(19) United States
(12) Patent Application Publication
(10) Pub. No.: US 2026/0094047 A1
(43) Pub. Date: Apr. 2, 2026

(54) ONLINE FORECASTING DETERMINATION FOR MULTI-SOURCE CLASSIFICATION AND DRIFT DETECTION

(71) Applicant: Dell Products L.P., Round Rock, TX (US)

(72) Inventors: Vinicius Michel Gottin, Rio de Janeiro (BR); Herberth Birck Fröhlich, Florianópolis (BR)

(21) Appl. No.: 18/899,129

(22) Filed: Sep. 27, 2024

(51) Int. Cl. G06N 20/00

(52) U.S. Cl. CPC G06N 20/00

(57) ABSTRACT

Online forecasting for multi-source classification and drift detection is disclosed. When performing an inference at a layer of a computing environment, the inputs to an inference model include most recent data from other layers. Due to delays, the most recent data to be included in the input is forecasted based on the most delayed layer. The forecasted values are input to a forecasting model that predicts an accuracy of the inference model. If the predicted accuracy is greater than a threshold accuracy, the inference is performed and drift detection is performed on the output of the inference.

### TECHNOLOGICAL FIELD OF THE DISCLOSURE

Embodiments disclosed herein generally relate to machine learning models, forecasting, and drift detection. More particularly, at least some embodiments relate to systems, hardware, software, computer-readable media, and methods for multi-source classification and drift detection in a computing system or environment based on forecasted values.

### BACKGROUND

Machine learning models can be configured to perform a wide variety of tasks. Once a model is trained for a given task, there is often a need to keep the model up to date for various reasons. When changes occur in the underlying dataset, the performance of the model may decline. One example of the decline in the model's performance is drift. Drift, for example, often relates to changes in the data being ingested or used by the model. Detecting drift is relevant to ensuring that the model is kept up-to-date.

There are various situations where there is value in working with current data. For example, a machine learning model may be configured to generate an output or inference using data generated by sensors operating in an environment. The data is often time-series data. In order to generate a reliable inference at a particular time, the model such receive the best available data for that particular time. Unfortunately, the nature of real networks often causes data to be delayed. As a result, the machine learning model may be generating outputs or inferences based on old data.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of layers in a computing system or environment;

FIG. 2 discloses aspects of forecasting data for model consumption;

FIG. 3A discloses aspects of forecasting data for classification and drift detection;

FIG. 3B discloses aspects of an original dataset and an induced dataset that includes modified or drifted data;

FIGS. 4A, 4B, 4C, and 4D disclose aspects of forecasting data or values for layers of a computing system;

FIG. 5 discloses aspects of relationships between a quality of the forecasting model and a quality of the drift detection;

FIG. 6 discloses aspects of determining a forecasting for application of an inference model to ensure adequate prediction quality and allow for drift detection; and

FIG. 7 discloses aspects of a computing device, system, or entity.

### DETAILED DESCRIPTION OF SOME EXAMPLE EMBODIMENTS

Embodiments disclosed herein generally relate to forecasting data (or values) for multi-source classification and drift detection. More particularly, at least some embodiments relate to systems, hardware, software, computer-readable media, and methods for performing forecasting operations for data or values used in multi-source classification and drift detection.

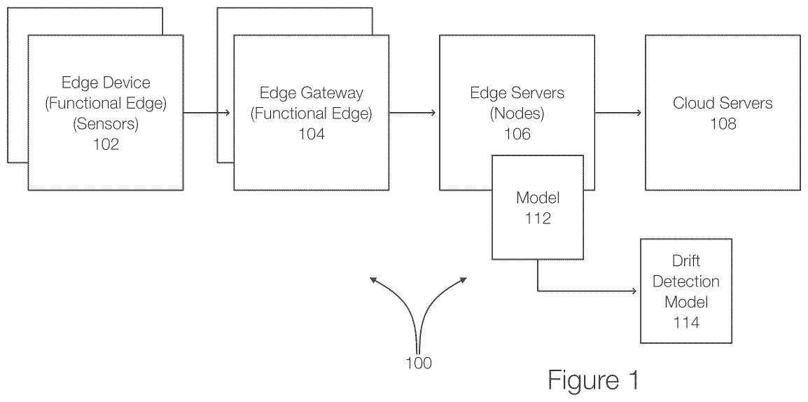

FIG. 1 discloses aspects of layers in a computing environment or computing system. FIG. 1 illustrates an edge device 102 that is configured to generate data or instances/values. For example, the edge device 102 may represent a sensor that generates data continuously, periodically, or the like. In some environments, such as a warehouse environment, a large number of sensors may be generating data. For example, sensors placed on nodes in the environment (e.g., automated devices, forklifts) may generate position data, inertial data, video data, GPS data, directional data, or the like. The edge device 102, which is representative of multiple edge devices, may also be an example of a functional edge.

Thus, data at or by the devices 102 may be representative of data that is generated at or collected in an environment. In some examples, the edge device 102 may be a computing device configured to collect data from sensors in an environment. The data generated at or collected by the edge device 102 may depend on the domain and/or on the functionality of the device 102.

The data or values generated at the devices 102 may flow through other layers of the computing system 100 such as an edge gateway 104, edge servers 106, and cloud servers 108.

The sensors 110, edge device 102, edge gateway 104, edge servers 106, and cloud servers 108 are examples of layers of a computing environment. As further illustrated, the system 100 may include multiple sensors 110, multiple edge devices 102, multiple edge gateways 104, and the like. The system 100 may use or receive input data (or values) from multiple sources distributed across the layers. Thus, data may originate in different layers.

In one example, an inference model 112 is deployed at a layer, such as at a near edge or at the edge servers 106 in this example. In this example, the term inference is used to identify a particular model and is not necessarily indicative of the model's operation. The inference model 112 may perform classification tasks and may be subject to a performance based drift detection method performed by a drift detection model 114.

The drift detection model 114 may be configured to determine whether a perceived decrease in a quality of the inference model 112 is due to changes in the underlying data distribution and may be configured to categorize the drift into a drift mode (e.g., recurring, sudden, gradual). When drift is detected by the drift detection model 114, the inference model 112 may be re-trained or replaced. Alternatively, maintenance may be performed on the inference model 112.

The acquisition and transmission of data across multiple layers of the system 100 may be subject to various delays. The time at which data from one device arrives at the inference model 112 may differ from the time at which data from another source arrives at the inference model 112. The delays in the system 100 can impact the operations of the inference model 112. For example, the model 112 can only perform inferences with the most-recent data from the currently most-delayed layer in the system 100.

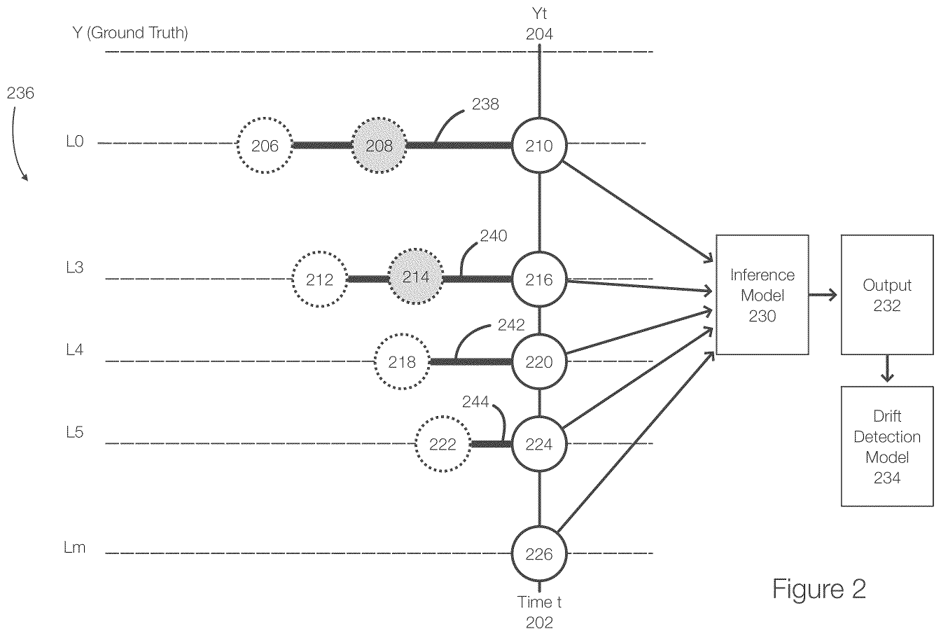

FIG. 2 discloses aspects generating inferences (or other model output) using data/values generated in a computing environment. FIG. 2 illustrates an example of layers (l₀, . . . , l₃, l₄, l₅, . . . , lₘ). Generally, layers closer to l₀ are associated with the far edge and layers associated with lₘ are associated with the near edge (or cloud). In this example, a model 230 may be configured to perform inferences based on data received from one or more of the layers 236. The set of input data is represented as X and the data associated with a timestamp t 202 is Xₜ. The output 232 of the inference model 230 for timestamp t is an approximation or estimate Ŷₜ of ground truth 204 Yₜ.

The transmission of data across the layers 236 is subject to varying delays, represented by the delays 238, 240, 242, and 244. As a result, at timestamp t, the model 230 is only able to perform with the most-recent data from the currently most-delayed layer. Thus, performing an inference by the model 230 at the timestamp t can only be performed using data from a previous timestamp (t−x), where x corresponds to the delay imposed by the data capture and transmission from the functional to the near edge.

In order to perform inference using data from timestamp t, the system must wait until timestamp (t+δ), where δ varies with the latencies and data acquisition varies from the layers. This introduces uncertainty in the system and delays the inferencing pipeline, including drift detection performed by the drift detection model 234.

In one example, the system could forecast data from the delayed layers. However, forecasting may introduce noise or deviation on the data and may induce a drop in the accuracy of the model 230.

Embodiments of the invention are configured to ensure or determine that the most recent possible data is used as input to the model 230. Providing the most recent data may, however, include forecasting data for one or more layers. However, embodiments of the invention are configured to forecast data such that the accuracy of the model is not impacted (or reduced) and such that drift detection by the drift detection model 234 is feasible in the pipeline.

More generally, the model 230 is deployed or associated with the layer lₘ and is trained to approximate available ground truth Y from data X originating at layers (l₀, . . . , lₘ). This is represented as M:Xₜ→Ŷₜ.

AS illustrated in FIG. 2, the input to the model includes data or values 210, 216, 220, 224, and 226. However, the data or values 208 and 214 are not yet available. The values 206, 212, 218, and 222 are available. In this example, the values 210, 216, 220, and 224 may represent forecasted values. Embodiments of the invention, however, relate to a model configured to generate forecasted data that reduces the impact of using forecasted data to generate inferences while still enabling the drift detection model 234 to detect drift.

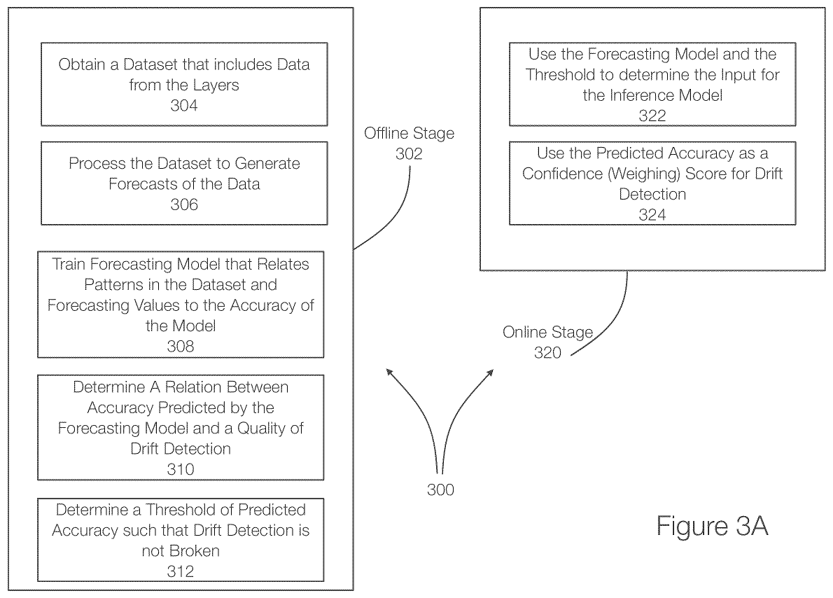

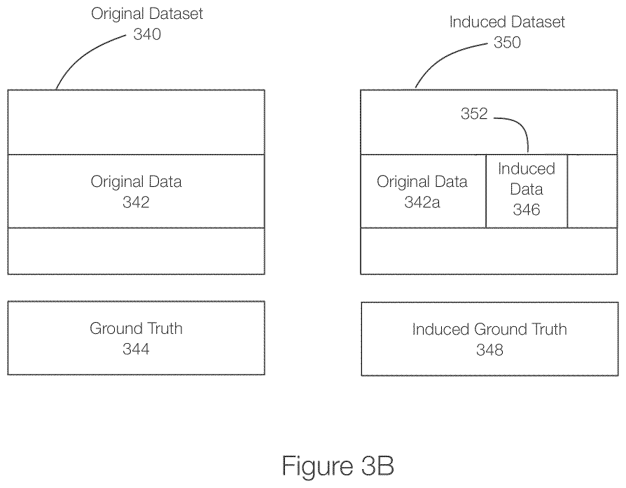

FIG. 3A discloses aspects of a method for forecasting determination for multi-source classification and drift detection. The method 300 includes an offline stage 302 and an online stage 320. In the offline stage 302, a dataset is obtained 304 that includes data from the layers of the computing system. Next, the dataset is processed 306 to generate forecasts of the data. Processing the data may further include generating an induced dataset. In one example, the induced dataset includes, in effect, drifted data.

Next, a forecasting model is trained 308 using the induced dataset to relate patterns in the data and forecasting values to the accuracy of the inference model. The forecasting model can be used to determine what the expected accuracy of the inference model will be given a certain forecasting. Next, a relation between the accuracy predicted by the forecasting model and a quality of the drift detection is determined 310. This allows a threshold of predicted accuracy to be determined 312 such that the drift detection model can successfully detect drift.

The online stage 320 includes deploying the forecasting model. More specifically, the forecasting model and the determined threshold are used to determine 322 the most appropriate input to the inference model. Stated differently, embodiments of the invention determine the input that satisfies a predicted accuracy greater than the threshold accuracy. The predicted accuracy may also be used 324 as a confidence or weighing score for performing drift detection.

More specifically, in the offline stage, a dataset X (induced dataset) is generated from the dataset X (original dataset). In one example, the induced includes or retains at least some of the original data from the layers. A generative model or simulation engine may also be used to generate the original dataset. Independent of how the induced dataset is obtained or generated, the induced dataset includes induced drift periods corresponding with ground truth for the drift induced data.

FIG. 3B discloses aspects of an original dataset and an induced dataset that includes modified or drifted data. FIG. 3B illustrates an original dataset 340 that includes original data 342. The original data 342 may be generated in or by the various layers (e.g., layers (l₀, . . . , lₘ)). The original data 342 in the original dataset 340 is processed to generate the induced dataset 350. Thus, the data in the induced dataset 350 includes a portion of the original data (original data 342a) and induced data 346. The induced dataset 350 is also associated with an induced ground truth 348.

In one example, the induced data 346 may correspond to a window of time and the induced dataset 350 may include multiple windows of induced data.

Next, the induced dataset is processed 306 to generate multiple forecasts of the data or values from the various layers. In one example, for each ground truth sample in the induced ground truth 348 (each timestamp t in Y̅), embodiments of the invention generate multiple forecasted data or values (or model inputs)

$${L}_{t}^{0} , {L}_{t}^{1} , …$$

and corresponding arrays

$$( {\overline{X}}_{t}^{0} , {\overline{X}}_{t}^{1} , … )$$

that capture the forecasted inputs.

In one example, processing 306 the dataset to generate multiple forecasts includes generating forecasted values. In one example, for each timestamp t, the most-delayed layer is identified and a timestamp a of the most-recent available data of the most-delayed layer is determined. Using the that data, a last-aligned sample may be identified and multiple combinations of forecasted inputs and their corresponding forecasted values are obtained or determined.

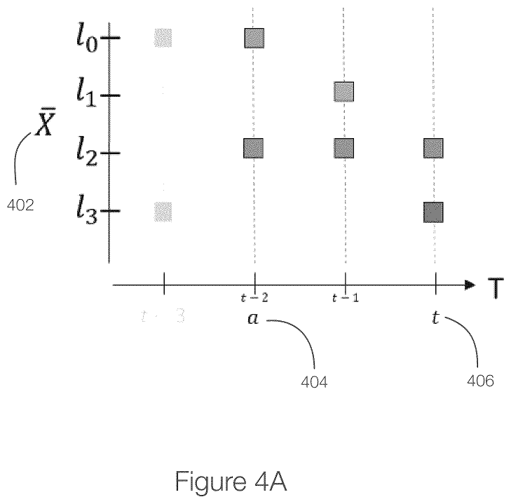

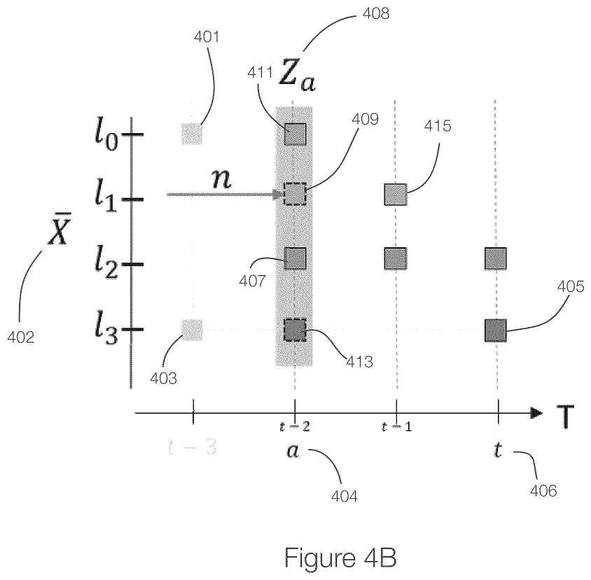

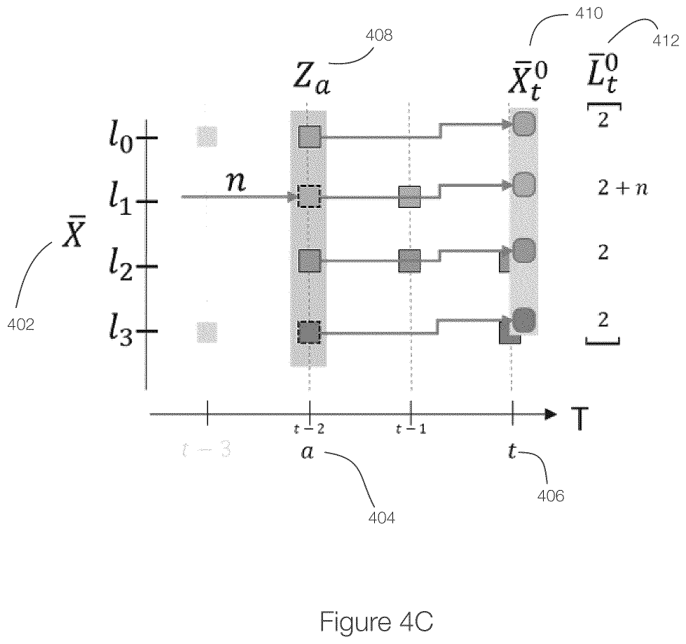

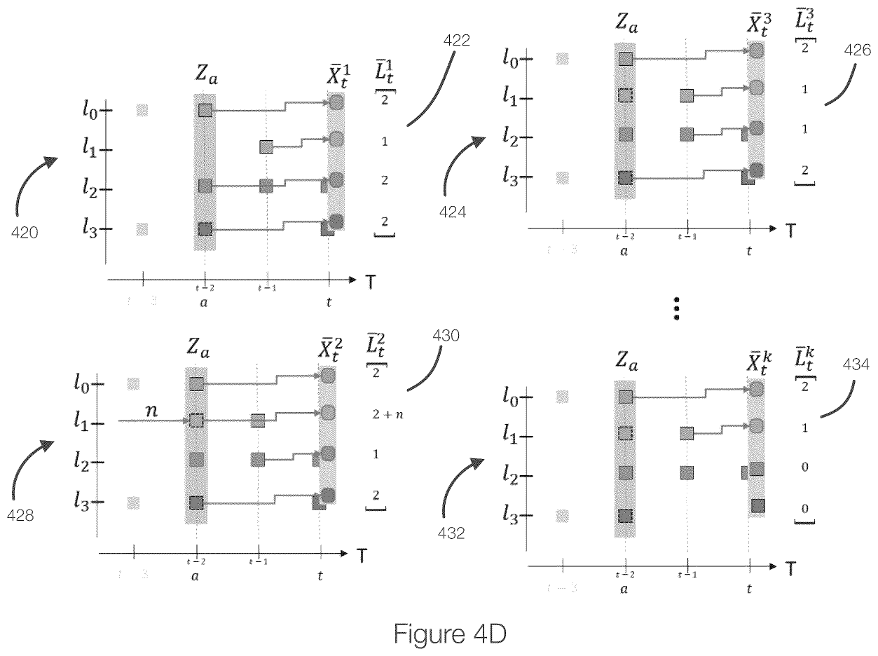

FIGS. 4A-4D illustrate examples of forecasting values or data. FIGS. 4A-4D illustrate simplified examples with data from four layers potentially available at layer l₃ at timestamp t. More specifically, data from each of the layers may include multiple values (e.g., multiple sensors) and may have high dimensionality. Thus, when discussing forecasting and communication of data from layer lᵢ, embodiments of the invention may be configured to operate with respect multiple values (e.g., readings from multiple sensors). When the data includes multiple values, embodiments of the invention are configured to account for this multidimensionality.

Although the data from each layer may include multiple values, embodiments of the invention are discussed in the context of a single value from each layer in FIGS. 4A-4D. Further, this example is discussed in the context of discrete timestamps. However, embodiments of the invention may collect data and the inference model may consider continuous times. In one example, discrete timestamps may be generated from a continuous time scale by sampling at regular intervals. This may require interpolation or extrapolation of closest-values to align the data from multiple layers at a particular discrete timestamp.

The examples of FIGS. 4A-4D include a scenario where, at a timestamp t, there are multiple combinations of possible inputs to the inference model (e.g., model 230), depending on the delays imposed by the communication across layers and available forecasting. Thus, FIG. 4A discloses aspects of data or values associated with layers l₀, . . . , l₃ of a system for an induced dataset 402. As illustrated, data at particular timestamps is available for some layers and not for others. At timestamp t−1, for example, data from layers l₁ and l₂ are available. Data for other layers may need to be forecasted in one example.

To determine the inputs for the inference model, the most-delayed layer at instant t 406 is determined and the timestamp of that layer is defined as timestamp a 404. In this example, the timestamp a 404 corresponds to the instant t−2 and is associated with the layer l₀.

In this example, timestamps prior to a 404 are not considered because, in practice, they imply longer forecasts than would have been necessary in the domain. Thus, embodiments of the invention may place a constraint on how far back in time a data or a value from a layer is considered. Thus, embodiments of the invention may limit the valid time period to a particular window, number of timestamps (when taken at regular intervals), or the like.

FIG. 4B discloses aspects of last aligned samples. More specifically from the timestamp a 404, last-aligned samples Zₐ 408 is obtained or determined. More specifically, the aligned samples 408 at timestamp a 404 includes data from each of the layers and may include estimated values.

In one example, data from layers l₁, l₂ and l₃ for the sample 408 at timestamp a 404 are not necessarily the most-recently available data at timestamp t. This accounts for possible delays in communication during practical applications.

Also represented in FIG. 4B are methods for obtaining the aligned sample 408 at timestamp a 404. More specifically, the values for the samples 408 at timestamp a 408 may be obtained in different manners.

For example, the value or data from a particular data may be actual data collected at timestamp i, as in layer l₂ in the example of FIG. 4B. Thus, the data or value 407 for the sample 408 for l₂ is the data collected at the timestamp a 404.

In another example, the data or value for the sample 408 may be collected or determined by repeating the last valid data collected for the layer, as illustrated in l₁. Thus, the data in the sample 408 for layer l₁ is replicated from n prior timestamps. More specifically in this example, the previous data collected at those layers is not shown but is assumed to be prior to t−3. In the example, the data forecasted for layer l₁ is replicated from n timestamps prior.

In another example, the last valid data collected at a layer may be interpolated, as illustrated in layer l₃. The data 413 in the sample 408 is determined by interpolation using the data 403 and the data 405.

The decision of how to obtain the data for each aligned sample is subject to considerations specific to the domain and the nature of the data. Once an aligned sample is determined, multiple potential values or inputs to the inference model may be forecasted for the timestamp t 406.

As previously indicated, communication delays in the computing environment may vary. Consequently, even though data is available at timestamp t in the collected dataset, this does not accurately represent when data will be available at layer lₘ as input for the inferencing model. In the example of FIG. 4B, layer l₁ includes a data 415 collected or generated at timestamp t−1. In this example, however, the array Zₐ 408 disregards the data 415. This allows embodiments of the invention to consider the possibility that the data at timestamp t−1 is not available yet, and that the data in t−2 may have to be used with forecasting. The same may apply to data in layers l₂ and l₃ in this example.

In one example, the input data or values in the sample 408 is associated with a timestamp a 404, which has the largest delay at timestamp t 406.

From the sample Zₐ 408, multiple forecast input arrays

$${\overline{X}}_{t}^{i}$$

are obtained or generated along with corresponding forecast array

$${L}_{t}^{i}$$

FIG. 4C discloses aspects of forecasting input arrays (or values for layers in the system). More specifically, FIG. 4C illustrates a sample 408 and values/arrays forecasted from the sample 408. Illustrates are samples

$${\overline{X}}_{t}^{0} 410$$

and an array

$${L}_{t}^{0} 412.$$

Thus, FIG. 4C illustrates a first forecast based on or starting with the sample 408.

The forecasted input values 410 are a measure of the time elapsed between the data collection and the timestamp t 408, which is a reference for decision making because the inference model operates at timestamp t 406. In FIG. 4C, the forecasting value of layer l₁ is shown as 2+n following that the data at timestamp a 404 was already ‘projected’ from n timestamps prior. This demonstrates that many forecast values may be generated and that the forecast inputs/arrays L can vary.

FIG. 4D illustrates example of generating multiple forecast input values from each sample. Generating the forecasts includes, in one example, determining the combinations of all possible forecasts given, by way of example, actual values at each layer in timestamps between timestamp a 404 and timestamp t 406. FIG. 4D further illustrates that, in some examples, the sample Zₐ 408 may not include a value as in the forecasting example 420.

As shown in FIG. 4D, some combinations may include zero-forecast (for values at timestamp t) for some layers. Except for the last layer lₘ, wherein the model M is applied (l₃, in the example) some samples may not be included. The reason is the communication delays between layers—if any delay is assumed between layer l₂ and l₃ (which is reasonable) then the data collected at l₂ will not be available for the inference model M at timestamp t.

For example, the forecast 420 includes a value for layer l₁ from timestamp t−1 while using a value from timestamp t−2 for the value of layer 12. Thus, the array

$${L}_{t}^{1} 422$$

includes values 2, 1, 2, 2. In contrast, the forecast 426 includes values from the timestamp t−1 for both of layers l₁, l₂ in the array 426. The forecast 428 includes a value of 2+n in the array 430 for the value of layer l₁. This reflects that the data for layer l₁ is replicated from n prior timestamps.

The forecast 432 illustrates another example where values for the layers l₂, l₃ are available at timestamp t.

FIG. 4D illustrates and a large number of varied forecasts for input to the inference model may be determined. The number of forecast inputs is sufficient to train a forecasting model K. Thus, a large number of input samples

$${L}_{t}^{0} , {L}_{t}^{1} ,$$

. . . and corresponding arrays

$${\overline{X}}_{t}^{0} , {\overline{X}}_{t}^{1} ,$$

. . . are generated. Because the forecasts have a combinatorial aspects, pruning may be performed. For example, arrays with values that are statistically improbably may be pruned. I another example, values from a same layer that are too close in time are dropped, which reduces the number of forecasts. Samples too close in time should naturally be close in value and will present similar forecasting.

In one example, the inputs have been forecasted and the forecasting arrays are generated. This allows a forecasting model to be trained to predict the relative performance of the inference model. The ground truth for training the forecasting model comes from the application of the inference model given

$${\overline{X}}_{t}^{0} , {\overline{X}}_{t}^{1} ,$$

. . . , compared to the ground truth in Y̅ₜ.

Training the forecasting model K includes using a model capable of dealing with an input such as a tuple (X̅ₜ, Lₜ). In one example, the forecasting model is a neural network that outputs a value of [0 . . . 1] that expresses a relative confidence in the result of the inference model for those types of samples when those values were obtained by forecasting of the levels expressed by Lₜ.

Once the forecasting model is trained, a drift-aware accuracy threshold z may be determined. In one embodiment, a minimum (predicted) accuracy threshold z for the inference model is determined that is greater than a predefined threshold q_{M} and that allows for a quality of the drift detection greater than a second predefined threshold q_{DD}. The relationship between larger forecasting values and the quality of the inference model M is a result of training the forecasting model K.

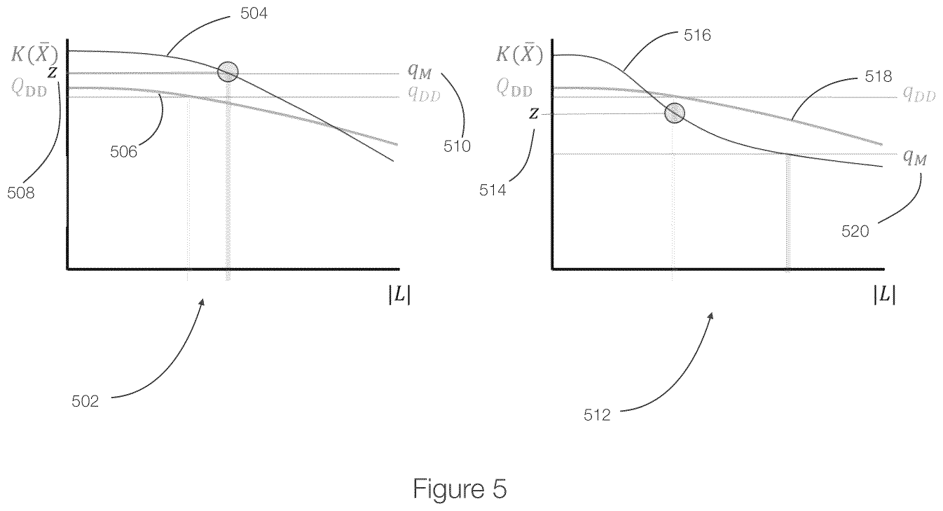

FIG. 5 discloses aspects of the relationships between the forecasting model K and the inference model M. Thus, the graphs 502 and 512 illustrates both a drop in the quality of the forecasting model and the quality of the drift detection Q_{dd} with respect to forecast value or size.

The graph 502 illustrates a quality 504 of the forecasting model and a quality of the drift detection 506. With larger forecasts (larger |L|), the graph 502 illustrates a drop in the quality 504 of the forecasting model and a drop in the quality 506 of the drift detection. The graph 502 illustrates a case where the required accuracy threshold for the inference model M, as evidenced by the results or output of the forecasting model K, does not impact the quality of the drift detection. In this case, the threshold z 508 is equal to the predefined threshold q_{M} 510 for the inference model M. One goal of embodiments of the invention is to obtain the largest forecasting values possible such than neither the inference model M nor the drift detection is impacted negatively beyond predetermined levels.

The graph 512 illustrates an example where the quality 518 of drift detection is more restrictive. In this example, the threshold z 514 of quality for the inference model is larger than the threshold 520.

The drift determination model receives the input of the inference model M and the output of the inference model M and yields a drift determination. The results of the drift detection module is compared to ground truth information. In one example, the quality values of the drift detection are obtained, in one example, as an aggregate metric of how correct and how timely the drift mode identifications are. In general, and by way of example, a quality score in the range [0 . . . 1] may be obtained for identification of drift modes.

With the threshold z and forecasting model K, the largest forecasting for the application of the inference model M can be determined, in an online matter, to ensure prediction quality and allow for drift detection.

For comparison purposes in a baseline approach without advantages of embodiments of the invention, the drift detection module or model requires that the inference model M wait for the most up-to-date data. However, this causes the inference model M to delay its inference about timestamp t to a timestamp t+δ. This is not ideal and may not even be feasible in time-sensitive domains.

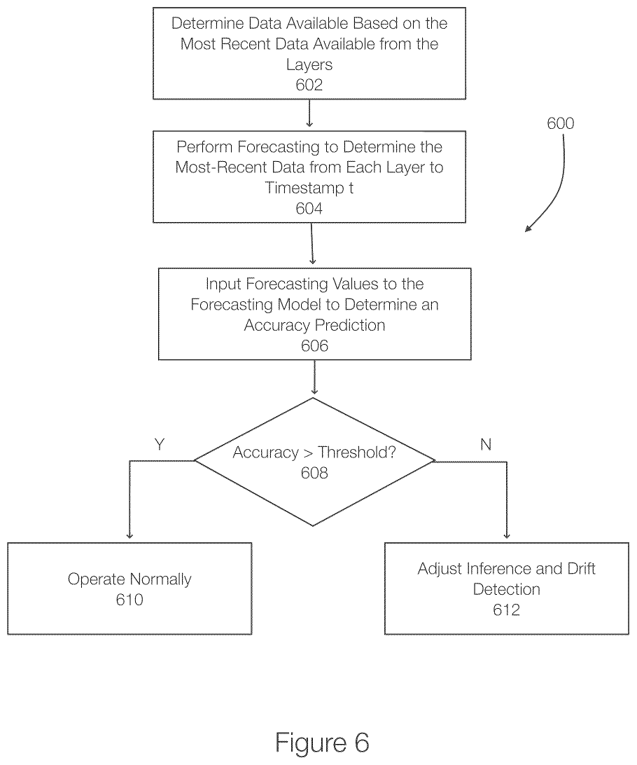

FIG. 6 discloses aspects of determining a forecasting for application of an inference model. The method 600 includes determining 602 the data available based on the most-recent data from each layer. The sample generated in this example may depend on the most-recent data of the most-delayed layer. This will be used to determine the input to the inference model at timestamp t.

Once the sample is determined or a timestamp is identified, the most-recent data is forecasted 604 for each of the layers. The forecasted values are input 606 to the forecasting model to obtain an accuracy prediction \tilde{Y}. This accuracy prediction is compared 608 to the predetermined threshold z.

If the predicted accuracy is greater than the threshold z (Y at 608), the forecasting likely does not affect the inference of the inference model M and the drift detection model or module DD. Because this is likely permissible, the system operates normally 610 at timestamp t without delays.

If the predicted accuracy is smaller or equal to the predetermined threshold (N at 608), one or more adjustments 612 may be performed. In one example, the inference of the inference model M is delayed for the acquisition of new values from one or more layers. In another example, an inference from the inference model is obtained and downstream tasks may be asked to consider the output of the forecasting model as a confidence score for the operation. For the drift detection model, this may include a signal to not operate.

In one example, the outputs of the forecasting model K are tracked over time. This may inform improvements to the overall system. For example, if the forecasting consistently causes issues (e.g., N at 608), the maximum forecasting allowed for the affected or problematic layers may be managed. The history of forecasting outputs may also indicate appropriate forecasting levels for each layer so that a new version of a drift detection module DD can be produced that allows for that forecasting level without intervention.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, data sample determination operations, forecasting operations, inference operations, drift detection operations, accuracy prediction operations, threshold determination operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other services may be performed on behalf of one or more clients. Some example cloud computing environments in which embodiments may be employed include Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form. Synthetic documents and/or corresponding labels are examples of data or objects.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: initiating a process to perform an inference operation with an inference model associated with a layer of a computing environment at a timestamp, determining data associated with a plurality of layers based most-recent data from each of the plurality of layers, forecasting values for each of the plurality of layers at the timestamp based on the determined data, and inputting the forecasted values into a forecasting model to obtain a predicted accuracy of the inference model, wherein normal operation is performed when the predicted accuracy is greater than a threshold accuracy, and adjustments to the normal operation are performed when the predicted accuracy is equal to or smaller than the threshold accuracy.

Embodiment 2. The method of embodiment 1, further comprising determining the data associated with the plurality of layers based on a prior timestamp associated with data from a most-delayed layer included in the plurality of layers.

Embodiment 3. The method of embodiment 1 and/or 2, further comprising determining values for each of the plurality of layers to determine a last aligned sample for the prior timestamp using one or more of interpolation, extrapolation, n prior entries, and actual data at the prior timestamp.

Embodiment 4. The method of embodiment 1, 2, and/or 3, further comprising forecasting values and corresponding arrays of values for the timestamp based on data from the layers between the prior timestamp and the timestamp.

Embodiment 5. The method of embodiment 1, 2, 3, and/or 4, further training the forecasting model based on using an induced dataset of values for the plurality of layers generated from a dataset of values for the plurality of layers.

Embodiment 6. The method of embodiment 1, 2, 3, 4, and/or 5, further comprising processing the induced dataset to generate multiple input values and arrays of values, wherein the forecasting model is trained to relate patterns in the data and forecasting values to an accuracy of the inference model.

Embodiment 7. The method of embodiment 1, 2, 3, 4, 5, and/or 6, further comprising determining a relation between the predicated accuracy from the forecasting model and a quality of drift detection performed by a drift detection module.

Embodiment 8. The method of embodiment 1, 2, 3, 4, 5, 6, and/or 7, further comprising determining the threshold accuracy, wherein the threshold accuracy is determined to ensure operation of the drift detection module.

Embodiment 9. The method of embodiment 1, 2, 3, 4, 5, 6, 7, and/or 8, wherein the adjustments include not adjusting the normal operation when the predicted accuracy is greater than the threshold accuracy.

Embodiment 10. The method of embodiment 1, 2, 3, 4, 5, 6, 7, 8, and/or 9, wherein the adjustments include using the prediction accuracy as a confidence score for detecting drift in an output of the inference model when the predicted accuracy is equal to or less than the threshold accuracy.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

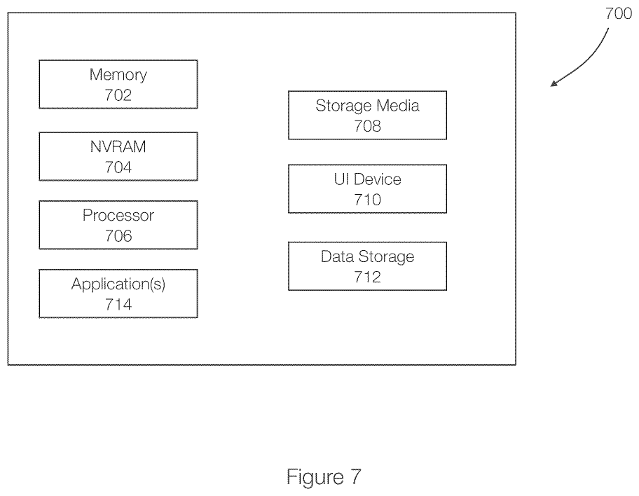

With reference briefly now to FIG. 7, any one or more of the entities disclosed, or implied, by the Figures and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

The device 700 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 700 may also represent a physical or virtual machine or server, an edge-based computing system, a cloud-based computing system, server clusters or other computing systems or environments. The device 700 may also represent multiple machines or devices, whether virtual, containerized, or physical. The device 700 may perform or execute steps or acts of the methods illustrated in the Figures.

The device 700 may represent a cloud-based system, an edge-based, system, an on-premise system, or combinations thereof. Document understanding and related operations may be performed using these types of computing environments/systems.

The described embodiments are to be considered in all respects only as illustrative and not restrictive. All changes which come within the meaning and range of equivalency of the claims are to be embraced within their scope.

What is claimed is:

1. A method comprising:
initiating a process to perform an inference operation with an inference model associated with a layer of a computing environment at a timestamp;
determining data associated with a plurality of layers based most-recent data from each of the plurality of layers;
forecasting values for each of the plurality of layers at the timestamp based on the determined data; and
inputting the forecasted values into a forecasting model to obtain a predicted accuracy of the inference model,
wherein normal operation is performed when the predicted accuracy is greater than a threshold accuracy, and
adjustments to the normal operation are performed when the predicted accuracy is equal to or smaller than the threshold accuracy.

2. The method of claim 1, further comprising determining the data associated with the plurality of layers based on a prior timestamp associated with data from a most-delayed layer included in the plurality of layers.

3. The method of claim 2, further comprising determining values for each of the plurality of layers to determine a last aligned sample for the prior timestamp using one or more of interpolation, extrapolation, n prior entries, and actual data at the prior timestamp.

4. The method of claim 3, further comprising forecasting values and corresponding arrays of values for the timestamp based on data from the layers between the prior timestamp and the timestamp.

5. The method of claim 1, further training the forecasting model based on using an induced dataset of values for the plurality of layers generated from a dataset of values for the plurality of layers.

6. The method of claim 5, further comprising processing the induced dataset to generate multiple input values and arrays of values, wherein the forecasting model is trained to relate patterns in the data and forecasting values to an accuracy of the inference model.

7. The method of claim 6, further comprising determining a relation between the predicated accuracy from the forecasting model and a quality of drift detection performed by a drift detection module.

8. The method of claim 7, further comprising determining the threshold accuracy, wherein the threshold accuracy is determined to ensure operation of the drift detection module.

9. The method of claim 1, wherein the adjustments include not adjusting the normal operation when the predicted accuracy is greater than the threshold accuracy.

10. The method of claim 1, wherein the adjustments include using the prediction accuracy as a confidence score for detecting drift in an output of the inference model when the predicted accuracy is equal to or less than the threshold accuracy.

11. A non-transitory storage medium having stored therein instructions that are executable by one or more hardware processors to perform operations comprising:
initiating a process to perform an inference operation with an inference model associated with a layer of a computing environment at a timestamp;
determining data associated with a plurality of layers based most-recent data from each of the plurality of layers;
forecasting values for each of the plurality of layers at the timestamp based on the determined data; and
inputting the forecasted values into a forecasting model to obtain a predicted accuracy of the inference model,
wherein normal operation is performed when the predicted accuracy is greater than a threshold accuracy, and
adjustments to the normal operation are performed when the predicted accuracy is equal to or smaller than the threshold accuracy.

12. The non-transitory storage medium of claim 11, further comprising determining the data associated with the plurality of layers based on a prior timestamp associated with data from a most-delayed layer included in the plurality of layers.

13. The non-transitory storage medium of claim 12, further comprising determining values for each of the plurality of layers to determine a last aligned sample for the prior timestamp using one or more of interpolation, extrapolation, n prior entries, and actual data at the prior timestamp.

14. The non-transitory storage medium of claim 13, further comprising forecasting values and corresponding arrays of values for the timestamp based on data from the layers between the prior timestamp and the timestamp.

15. The non-transitory storage medium of claim 11, further training the forecasting model based on using an induced dataset of values for the plurality of layers generated from a dataset of values for the plurality of layers.

16. The non-transitory storage medium of claim 5, further comprising processing the induced dataset to generate multiple input values and arrays of values, wherein the forecasting model is trained to relate patterns in the data and forecasting values to an accuracy of the inference model.

17. The non-transitory storage medium of claim 16, further comprising determining a relation between the predicated accuracy from the forecasting model and a quality of drift detection performed by a drift detection module.

18. The non-transitory storage medium of claim 7, further comprising determining the threshold accuracy, wherein the threshold accuracy is determined to ensure operation of the drift detection module.

19. The non-transitory storage medium of claim 11, wherein the adjustments include not adjusting the normal operation when the predicted accuracy is greater than the threshold accuracy.

20. The non-transitory storage medium of claim 11, wherein the adjustments include using the prediction accuracy as a confidence score for detecting drift in an output of the inference model when the predicted accuracy is equal to or less than the threshold accuracy.
